(19) United States
(12) Patent Application Publication
(10) Pub. No.: US 2007/0291100 A1
(43) Pub. Date: Dec. 20, 2007

(54) PRINT HEAD ASSMEBLY AND METHOD USED WITH IMAGE FORMING APPARATUS

(75) Inventors: Kyung-pyo Kang, Suwon-si (KR); Hideaki Kawada, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/746,292

(22) Filed: May 9, 2007

(30) Foreign Application Priority Data
Jun. 19, 2006 (KR) 2006-55105

(51) Int. Cl. G01D 15/10

(52) U.S. Cl. 347/220

(57) ABSTRACT

An image forming apparatus includes a thermal print head part; a supporting arm coupled to the thermal print head part to support the thermal print head part to be capable of moving between a printing position and a waiting position; a driving cam to be rotatably driven together with a cam profile thereof; and a cam lever having an operating lever to move along the cam profile according to a rotation of the driving cam, and a main pressurizing part to apply pressure to the thermal print head part so that the thermal print head part can move to the printing position. The main pressurizing part may be in contact with a thermal print head of the thermal print head part and may be used to apply adequate pressure to the thermal print head to permit the thermal print head to reciprocate between the printing position and the waiting position.

### CROSS-REFERENCE TO RELATED APPLICATIONS

This application claims priority from Korean Patent Application No. 2006-0055105, filed on, Jun. 19, 2006, in the Korean Intellectual Property Office, the disclosure of which is incorporated herein in its entirety by reference.

### BACKGROUND OF THE INVENTION

1. Field of the Invention

The present general inventive concept relates to an image forming apparatus, and more particularly, to an image forming apparatus having an improved configuration to ascend and descend a thermal print head (TPH) assembly.

2. Description of the Related Art

In general, an image forming apparatus is coupled to a host apparatus in which image data is stored. The image forming apparatus is used to print an image data on a printing paper through ink or toner according to an output signal applied from the host apparatus. The image forming apparatus may be an inkjet type, an electrophotographic type, and a dye sublimation type device.

As technology has been developed recently, an image forming apparatus coupled to a portable host apparatus is capable of directly transferring and receiving image data. Especially, as photo image data capturing technology using portable cameras and cellular phones has advanced, their use has increased rapidly. After the photo image is taken, a user frequently outputs photo image data through an image forming apparatus.

Accordingly, image forming devices (and associated technology) limited to output photo images have advanced rapidly. Among such devices, a dye sublimation type device has an advantage in that the printed image is less susceptible to be deteriorated by moisture, and due to a matter property, can be maintained for a long time, and provide a high print resolution. Thus, dye sublimation type image forming devices have been widely used in an image forming apparatus for printing photo image data.

FIG. 1 is a schematic view illustrating a configuration of a general dye sublimation typed image forming apparatus 1. As illustrated in FIG. 1, the image forming apparatus 1 includes a paper feeding part 20 to feed printing paper, an ink ribbon supplying roller 31 to supply an ink ribbon R made of layers of yellow, magenta, and/or cyanide, and to overcoat a thermal print head 41 (hereinafter referred to as TPH), and an ink ribbon return roller 33 to return the ink ribbon R supplied to the TPH 41. The TPH 41 is used to transmit ink coated on the ink ribbon R onto the paper with the application of heat and/or pressure to the ink ribbon R. A paper discharging part 70 to discharge an image-formed on the paper to the outside is also provided.

Here, the TPH 41 is provided to move between a printing position to heat and to pressurize the ink ribbon R onto the printing paper and a waiting position separated from the ink ribbon R by a TPH assembly 40. In FIG. 1, additional rollers 21 (pickup roller), 45 (platen roller), 51 (driving roller), 53 (idle roller) and 71 (discharging roller) are provided as illustrated together with parts 50 (transferring unit) and 60 (ink ribbon position detecting sensor) within casing 10. In FIG. 1, the dashed arrows illustrate the paper path from the paper feeding part 20 to point B and then ultimately to point A.

FIG. 2A is a schematic view illustrating a configuration of a conventional TPH assembly 40A disclosed in American Patent Publication No. 20050024473. The above conventional TPH assembly 40A includes a supporting arm 43 to support the TPH 41, a driving gear 47a and a linking gear 47b driven by a motor (not illustrated), and an up-down gear 46 used to rotatably engage with the linking gear 47b when the driving gear 47a rotates.

In the conventional TPH assembly 40A with this configuration, the linking gear 47b is provided on the same rotational axis as that of the driving gear 47a which rotates when an output signal is applied. Thus, the driving gear 47a is rotated to cause the up-down gear 46 to apply pressure to the TPH 41 by the rotating force of the linking gear 47b. Accordingly, the TPH 41 is moved to the printing position by the applied pressure.

However, in the TPH assembly 40A with this configuration, pressure is applied by engagement of teeth of the linking gear 47b and the up-down gear 46 to move the TPH 41. Also, a dynamic impulse is sequentially applied to the up-down gear 46 and the TPH 41 whenever the teeth are engaged. Accordingly, there is a problem in that a shaft accommodating part 48 to accommodate a rotating shaft 49 of the up-down gear 46 tends to wear out as illustrated in the enlarged view of FIG. 2A′. When the rotating shaft 49 wears out, the up-down gear 46 does not adequately rotate and remains essentially idle. Thus, the up-down gear 46 does not operate properly, and the TPH 41 does not move smoothly as desired. Thus, there is a need to provide a more robust design to endure any impulses generated when multiple gears are engaged. Such extra design causes manufacturing costs to increase.

Meanwhile, FIG. 2B is a view illustrating a configuration of a TPH assembly 40B disclosed in Japanese First Patent Publication No. 2005-297394. The TPH assembly 40B illustrated in FIG. 2B includes a TPH 41, driving gears 47a and 47b, an up-down gear 46 to rotate in engagement with the driving gear 47b, and a pressurizing part 48 to apply pressure to the TPH 41 upon proper rotation of the up-down gear 46. In the conventional TPH assembly 40B with this configuration, the up-down gear 46 rotates when the driving gear 47b rotates, and accordingly, the pressurizing part 48 applies pressure to the TPH 41 to move it to a printing position.

However, in this case, when the pressurizing part 48 applies pressure to the middle position of the TPH 41, the applied pressure transferred to the TPH 41 may not be uniformly applied. Therefore, there is a problem in that an image formed with such TPH assembly may not print uniformly.

### SUMMARY OF THE INVENTION

The present general inventive concept provides an image forming apparatus including a TPH assembly that may be used to transfer pressure (e.g., sometimes together with heat) uniformly and stably to the TPH.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing an image forming apparatus including: a thermal print head part; a supporting arm in which a free end part separated from a predetermined rotating center point is coupled to the thermal print head part and supports the thermal print head part to be capable of moving between a printing position and a waiting position; a driving cam which is rotatably driven and a cam profile is formed therein; and a cam lever having an operating lever to move along the cam profile according to the rotation of the driving cam, and a main pressurizing part to rotate about a rotating shaft to apply pressure to the thermal print head part so that the thermal print head part can move to the printing position according to the movement of the operating lever.

A cam profile can be provided such that its radius can be gradually reduced.

A radius difference of the cam profile can be provided which corresponds to a height difference between the waiting position and the printing position of the thermal print head part.

The thermal print head part can include a thermal print head, and an elastic part which is provided in an upper end part of the thermal print head and to apply an elastic force to the thermal print head.

The supporting arm can include an elastic coupling part coupled to the elastic part, and an elastic part pressurizing projection which may be pressurized by the main pressurizing part when the cam lever rotates so that the elastic coupling part can be used in conjunction to apply pressure to the elastic part.

The main pressurizing part of the cam lever can be formed to have the same radius from the rotating shaft.

Some area on an outer circumference of the cam lever can be curved-formed so that the elastic part pressurizing projection can slidingly move when the cam lever rotates.

The cam lever can include a shaft coupling part coupled with the rotating shaft in a non-circular shape.

An image forming apparatus may further include an elastic member to apply an elastic force to the supporting arm so that the thermal print head part in the printing position can be elastically returned to the waiting position.

The supporting arm can be provided on each of opposite end sides of the thermal print head part.

The driving cam can include gear teeth on its outer circumference.

The foregoing and/or other aspects and utilities of the present general inventive concept may also be achieved by providing an image forming apparatus including: a thermal print head part which is used to pressurize and/or heat a printing paper having a thermal chromogenic layer to form an image on the printing paper; a supporting arm in which a free end part separated from a predetermined rotating center point is coupled to the thermal print head part and used to support the thermal print head to move between a printing position and a waiting position; a driving cam which can be rotatably driven and a cam profile may be formed therein; and a cam lever having a driving lever to move along the cam profile of the driving cam, and a main pressurizing part to rotate about a rotating shaft to apply pressure to the thermal print head part so that the thermal print head part can move to a printing position according to movement of the operating lever.

The foregoing and/or other aspects and utilities of the present general inventive concept may also be achieved by providing a thermal print head assembly including: a thermal print head part which is used to heat and/or pressurize an ink ribbon onto a printing paper to form an image on the printing paper; a supporting arm in which a free end part separated from a predetermined rotating center point is coupled to the thermal print head part and used to support the thermal print head part to move between a printing position and a waiting position; a driving cam which is rotatably driven and a cam profile may be formed therein; and a cam lever having a driving lever to move along the cam profile of the driving cam, and a main pressurizing part to rotate about a rotating shaft to apply pressure to the thermal print head so that the thermal print head can move to a printing position according to movement of the operating lever.

The foregoing and/or other aspects and utilities of the present general inventive concept may also be achieved by providing a print head assembly including a print head part to apply heat or pressure to a printing paper to form an image on the printing paper with an ink supply, and a driving cam coupled to the print head part, the driving cam having a cam profile to move the print head part between a waiting position to a printing position upon rotation of the driving cam.

The driving cam can also be a rotatable driving cam.

The driving cam can be a rotatable driving cam and can have a cam profile that is spiral in shape having a starting radius and an ending radius with the starting radius larger than the ending radius.

The cam profile starting radius can be incrementally or gradually decreased from the starting radius to the ending radius.

The cam profile can have a starting point and an ending point with a starting radius that corresponds to an arc beginning at the starting point and an ending radius that corresponds to an arc ending at the ending point and further providing that the starting point corresponds to a waiting position and the ending point corresponds to a printing position of the print head assembly.

The cam profile can be coupled to the print head part via a cam lever.

The cam lever can include an operating lever to rotatably move or to slidably move with or within the cam profile upon rotation of the driving cam.

The cam profile can be formed in the driving cam.

The foregoing and/or other aspects and utilities of the present general inventive concept may also be achieved by providing a method of reducing the force of the impulses or the number of impulses transferred by a print head assembly. The print head assembly may have a driving cam with a cam profile, an operating lever and a print head part. The method may include coupling the operating lever to move the print head part between a waiting position and a printing position upon rotation of the driving cam and the cam profile, coupling the operating lever to move along the cam profile upon rotation of the driving cam, rotating the driving cam, moving the operating lever along the cam profile by rotating the driving cam, and moving the print head part between the waiting position and the printing position in correspondence with rotating the driving cam and moving the operating lever along the cam profile. The cam profile may have a spiral shape having a starting radius that gradually or incrementally decreases to an ending profile.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a schematic view illustrating a configuration of a general image forming apparatus.

FIGS. 2A, 2A′ and 2B are schematic views illustrating a configuration of a TPH assembly of a conventional image forming apparatus.

FIG. 3 is a schematic view illustrating a configuration of an image forming apparatus that may be used in conjunction with one or more embodiments of the present general inventive concept.

FIGS. 3A and 3B are perspective views illustrating a configuration of a TPH assembly in a printing position of an image forming apparatus according to embodiments of the present general inventive concept.

FIGS. 4A and 4B are perspective views illustrating a configuration of a TPH assembly in a waiting position of an image forming apparatus according to embodiments the present general inventive concept.

FIG. 5 is an enlarged schematic view illustrating a configuration of a driving cam of a TPH assembly according to an embodiment of the present general inventive concept.

FIG. 6 is a graph plotting a position change of a driving lever and a pressurizing projection by a rotation of a driving cam according to one or more embodiments of the present general inventive concept.

FIGS. 7A and 7B are graphs plotting impulses transferred to a rotating shaft by an operation of a TPH assembly according to a conventional TPH assembly (e.g., FIG. 7A) and according to one or more embodiments of the present general inventive concept (e.g., FIG. 7B).

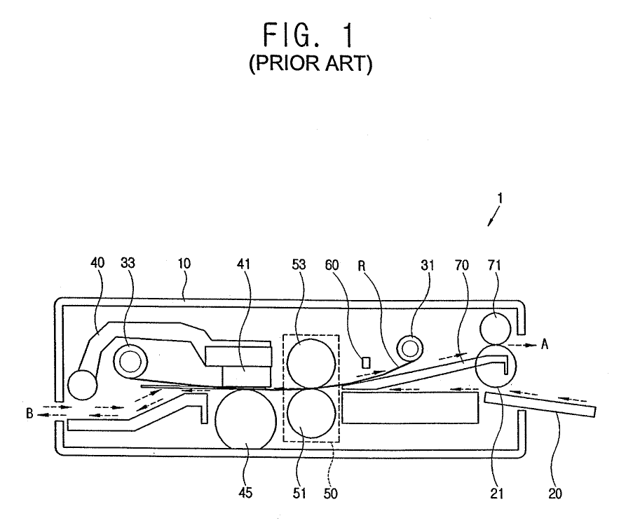

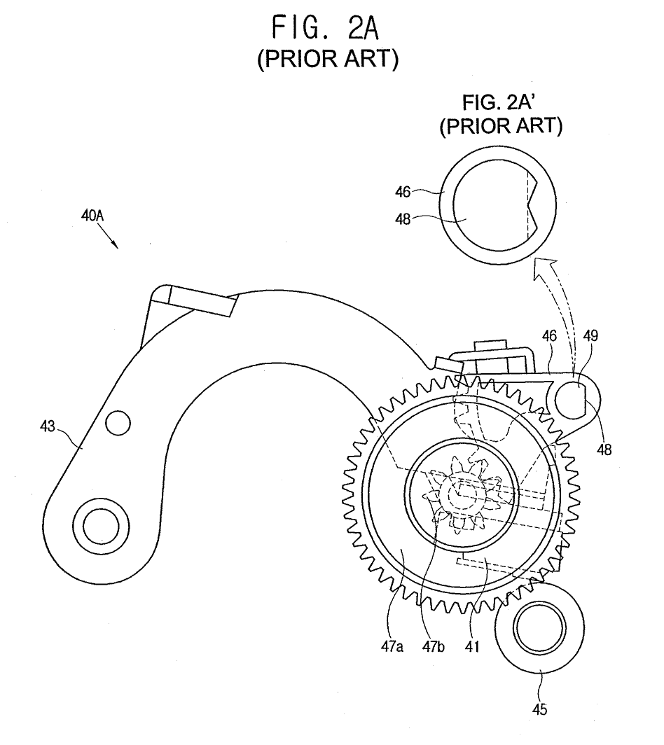

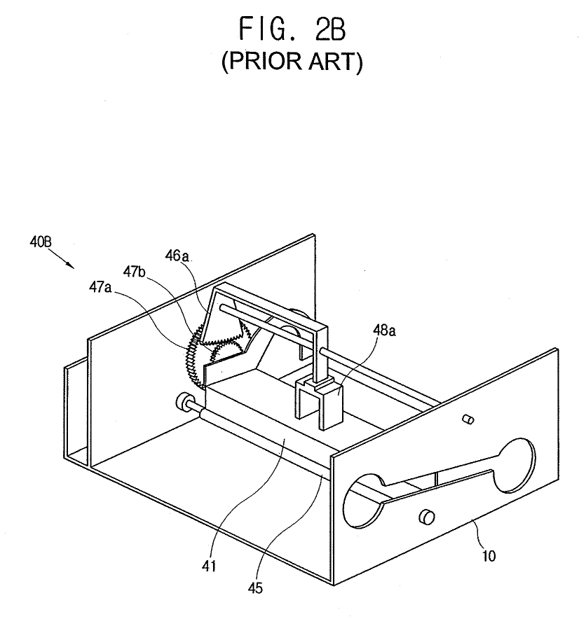

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

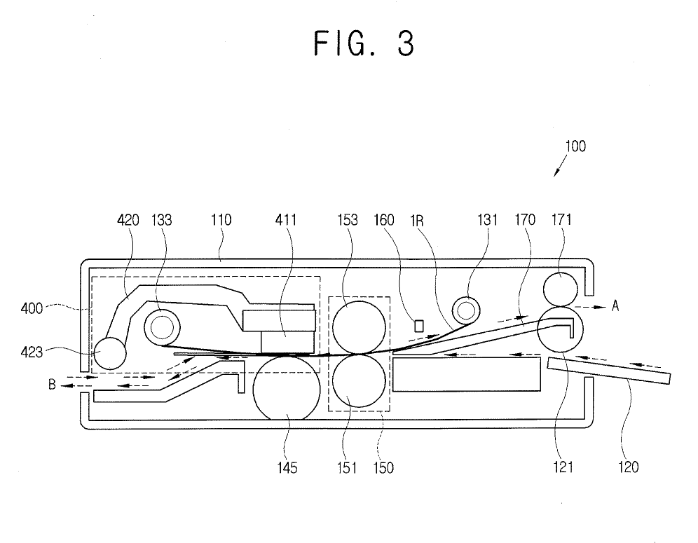

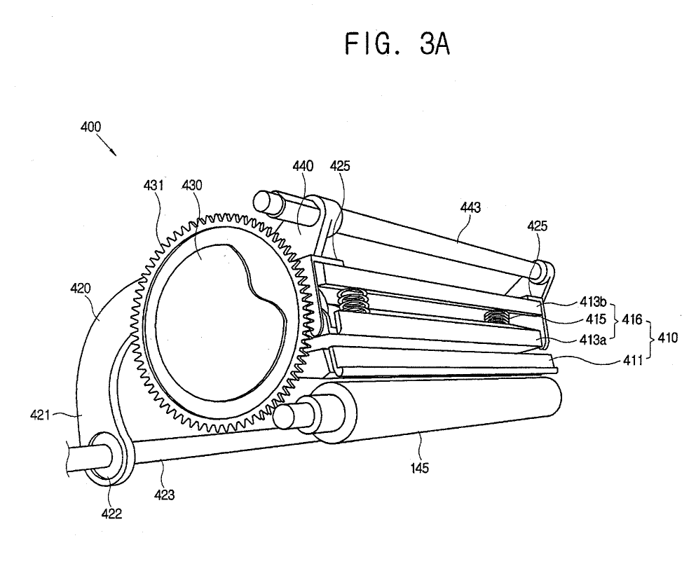

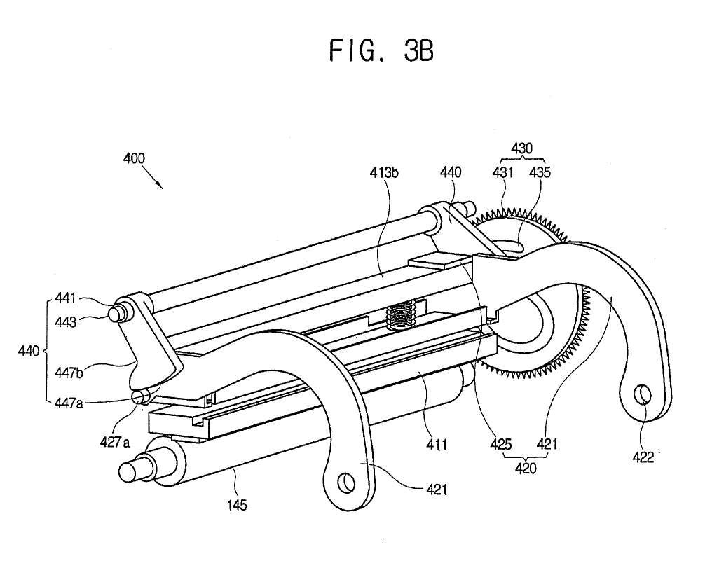

As illustrated in the embodiments of FIGS. 3, 3A and 3B of the present general inventive concept, an image forming apparatus 11 includes a casing 110, a paper feeding part 120 to feed a printing paper inside the casing 110, an ink ribbon supplying roller 131 to supply an ink ribbon 1R coated with ink, an ink ribbon return roller 133 to accept the ink ribbon 1R, a thermal print head assembly 400 (hereinafter referred to as “TPH assembly”) to apply pressure to the ink ribbon 1R in contact with a printing paper, a platen roller 145 provided to face the TPH assembly 400 and to support a printing paper toward a TPH 411 when an image is formed (or printed) on a printing paper, a transferring unit 150 to transfer a printing paper fed from the paper feeding part 120 toward a TPH part 410, and a paper discharging part 170 to discharge a printed paper to the outside.

As illustrated in FIG. 3, the paper feeding part 120 can passively feed a printing paper from an outside of the casing 110, or can automatically feed a printing paper by mounting a paper storing part (not illustrated) to store printing papers inside the casing 110. According to an embodiment of the present general inventive concept, in the case of feeding a printing paper, the printing paper in the paper feeding part 120 is transferred to the TPH part 410 by a friction force generated when a pickup roller 121 rotates. Here, the pickup roller 121 not only feeds a printing paper toward the TPH part 410, but also discharges a paper on which an image is formed in the TPH part 410 in engagement with a discharging roller 171 to the outside.

The transferring unit 150 includes a driving roller 151 and an idle roller 153 to be rotated in engagement with the driving roller 151 to apply pressure to a printing paper. In general, after a printing paper is fed from the paper feeding part 120 to form an image on the paper, the transferring unit 150 is used to hold one part of a printing paper to stably form the image on the printing paper until the paper is discharged through the discharging part 170.

The ink ribbon supplying roller 131 and the ink ribbon return roller 133 which may be provided on opposing sides with respect to the TPH part 410 enable a yellow (Y), a magenta (M), a cyanide (C), and/or an overcoating layer coated in the ink ribbon 1R to be rightly arranged (or transferred) on an image-forming side of the printing paper. The rotating speed of the ink ribbon supplying roller 131 and the ink ribbon return roller 133 is desirably set to correspond to the image forming speed of the TPH part 410, according to an embodiment of the present general inventive concept.

Meanwhile, between the paper feeding part 120 and the TPH part 410 may be provided a plurality of paper position detecting sensors (not illustrated) to detect a feeding condition and a position of the printing paper. Also, on one side of the ink ribbon supplying roller 131 may be provided an ink ribbon position detecting sensor 160 to detect a position of the ink ribbon 1R. The ink ribbon 1R may include a sorting layer so that the ink ribbon position detecting sensor 160 can sort respective colors of the ink ribbon 1R.

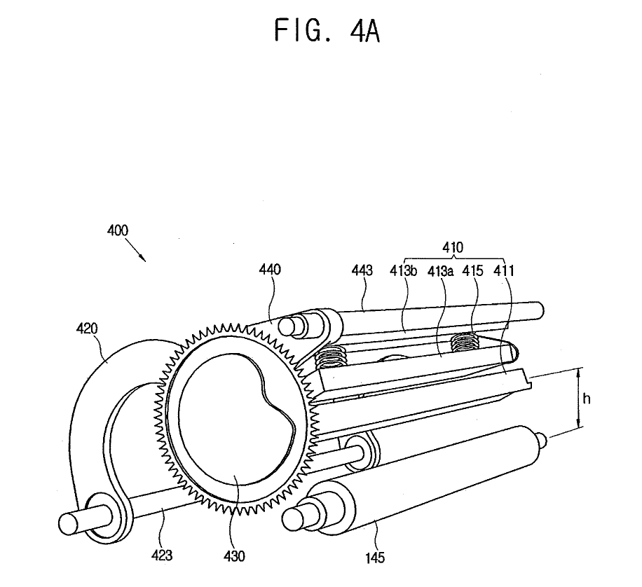

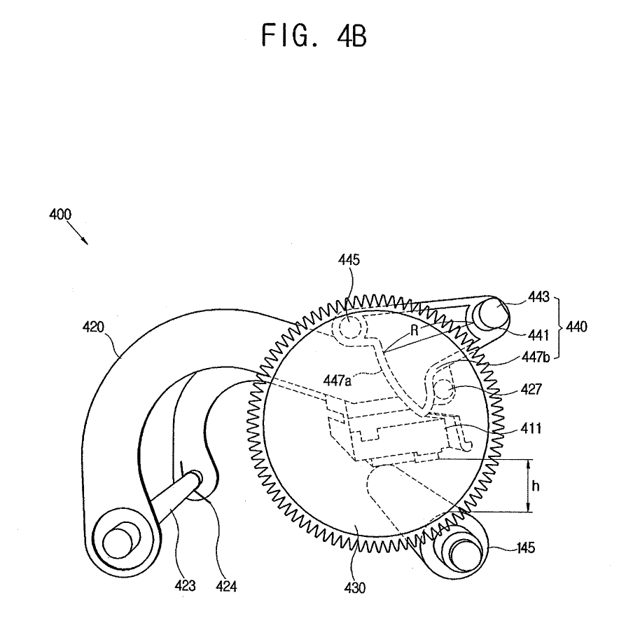

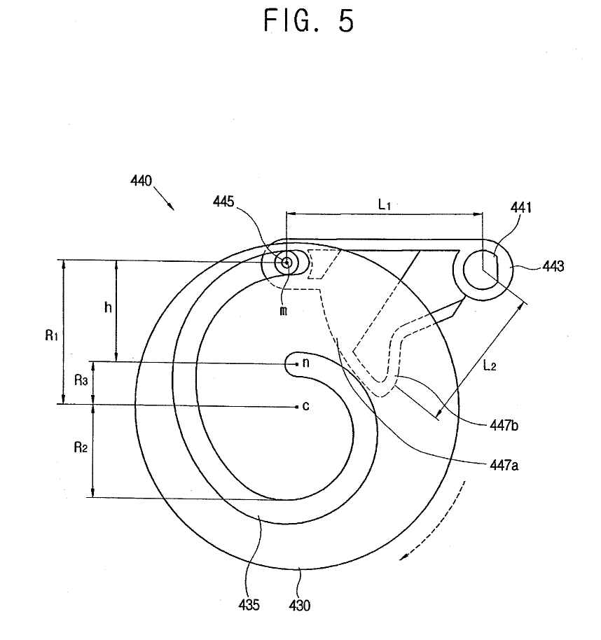

As illustrated in the embodiments of FIGS. 3, 3A, 3B, 4A and 4B of the present general inventive concept, the TPH assembly 400 includes the TPH part 410 to apply heat and/or pressure to the ink ribbon 1R, a supporting arm 420 of which a free end part is coupled to the TPH part 410. The supporting arm is used to move the TPH part 410 between a printing position and a waiting position. As illustrated in the embodiments of FIGS. 3, 3A, 3B, 4A, 4B and 5 of the present general inventive concept, a motor (not illustrated), a driving cam 430 which is connected to the motor (not illustrated) to be driven and a cam profile 435 (see FIGS. 3B and 5) may be formed therein. According to an embodiment of the present general inventive concept, a cam lever 440 which is connected with the cam profile 435 of the driving cam 430 is used to transfer a rotation force of the driving cam 430 to the supporting arm 420.

As illustrated in FIG. 3A, the TPH part 410 includes the TPH 411 to apply heat to the ink ribbon 1R, and an elastic part 416 which is provided in an upper part of the TPH 411 and used to apply pressure to the TPH 411 so that the TPH 411 can apply sufficient heat to the ink ribbon. In the TPH 411 may be arranged a plurality of tiny thermal elements at a predetermined interval (or intervals) corresponding to the width of a printing paper. Here, the thermal elements may be provided in proper numbers to provide the desired resolution of the image of the image forming apparatus 11. The respective thermal elements may be controlled independently to generate the heat needed to form the image.

The elastic part 416 includes a lower part frame 413a which couples to the TPH 411, an upper part frame 413b which couples to the supporting arm 420, and an elastic member 415 which is provided between the lower part frame 413a and the upper part frame 413b and used to apply an elastic force to the TPH 411 when pressurized by the supporting arm 420. The lower part frame 413a may be coupled to the TPH 411 by various other known coupling methods, and the upper part frame 413b may be coupled to an elastic part coupling part 425 of the supporting arm 420. The upper part frame 413b couples to the elastic part coupling part 425 to apply pressure to the elastic member 415 with rotation of the supporting arm 420.

The elastic member 415 is used to elastically apply pressure to the TPH 411 and to enable the TPH 411 to apply heat to the ink ribbon 1R and to maintain its printing position until an image is formed on the paper when the upper part frame 413b is used to apply pressure to the TPH 411 by a position movement of the supporting arm 420.

The elastic member 415 according to an embodiment of the present general inventive concept may be provided in the shape of a coil spring, but other shapes of elastic members which can supply proper elastic force to the TPH 411 may also be used. Here, the elastic member 415 is desirably provided to have a proper elastic coefficient in consideration of an elastic force necessary to apply the needed pressure, and the elastic member 415 may be provided to be on opposite end sides of the TPH 411 and/or may have a plurality of members suitable to balance the pressure on TPH 411 (e.g., to apply uniformly and/or stably).

Meanwhile, the upper part frame 413b and the lower part frame 413a of the elastic part 416 are desirably provided to have a length shorter by a predetermined amount than a length of the TPH 411. Such configuration is used to prevent the elastic part 416 from interfering with cam lever 440 when the cam lever 440 is used to apply pressure to the TPH 411.

As illustrated in FIGS. 3A, 3B and/or 4B, the supporting arm 420 includes an arm main body 421, a shaft accommodating part 422 provided in one end part of the arm main body 421 to accommodate an arm rotating shaft 423. The elastic part coupling part 425 is provided on opposite end sides of the arm main body 421 and coupled to the upper part frame 413b of the TPH part 410. A pressurizing projection 427 is projectedly-provided on one side of the opposite end sides of the arm main body 421. Pressure is applied to the pressurizing projection 427 when in propercontact with an auxiliary pressurizing part 447b of the cam lever 440. As illustrated in FIG. 3B, an auxiliary pressurizing projection 427a is provided to rotate against main pressurizing part 447a on the side of the TPH assembly 400 opposite the side with the illustrated driving cam 430.

The arm main body 421 may be provided as one plate member or a combination of two or more plate members. As illustrated in FIG. 3B, the arm main body 421 is curved-formed or bent-formed to have a predetermined angle. Between the shaft accommodating part 422 and the arm rotating shaft 423 is provided a torsion spring 424 (refer to FIG. 4B) to apply an elasticity to the supporting arm 420 so that the supporting arm 420 pressurized to the printing position can return to the waiting position.

The elastic part coupling part 425 extends along a curve from the arm main body 421 to be coupled to the upper part frame 413b of the elastic part 416. The elastic part coupling part 425 can be extended by a predetermined length to be in parallel with a planar surface of the upper part frame 413b to apply sufficient pressure to the upper part frame 413b. The elastic part coupling part 425 may be coupled to the upper part frame 413b by other known coupling methods such as a spiral coupling, a rivet coupling, and an adhesive agent coupling, etc.

Meanwhile, the angle which the elastic part coupling part 425 and the upper part frame 413b make is desirably provided to apply proper pressure to the ink ribbon 1R and the printing paper in a position facing the platen roller 45.

As illustrated in FIG. 4B, the pressurizing projection 427 projected from the arm main body 421 is used to provide adequate contact with the auxiliary pressurizing part 447b when the TPH 411 is in the waiting position. The pressurizing projection 427 moves along the shape of the auxiliary pressure supplying part 447b of the cam lever 440 when the driving cam 43 rotates ultimately pushing the TPH 411 into the printing position.

Also, as illustrated in FIG. 3B, downward pressure on the supporting arm 420 is applied (or maintained or distributed) a main pressurizing part 447a of the cam lever 440 (onto auxiliary pressurizing projection 427a) ultimately causing TPH 411 to move into the printing position. Such cooperation between the supporting arm 420 and the main pressurizing part 447a (and the auxiliary pressurizing projection 427a), and the auxiliary pressurizing part 447b (and the main pressurizing projection 427), is used to enable the elastic part coupling part 425 to apply adequate pressure to the upper part frame 413b. The pressurizing projections 427 and 427a are desirably provided to be thick enough and with a predetermined diameter sufficient to move in contact with the cam lever 440.

The elastic part coupling part 425 and the pressurizing part 427 (and/or 427a) can be integrated with the arm main body 421. Also, the arm main body 421 can be provided as a rigid body with enough hardness to be used for a long time without being deformed, especially due to the pressures applied during repeated printing operations.

According to an embodiment of the present general inventive concept, the motor (not illustrated) can be supplied with a signal from a predetermined controller (not illustrated) which can be operated in response to an applied output signal. Between the motor and the driving cam 430 may be provided a gear (not illustrated) or other known transferring part (or configuration of parts) sufficient to transfer a rotation force of the motor to the driving cam 430.

As illustrated in FIG. 3B, the driving cam 430 according to an embodiment of the present general inventive concept may be supplied with the rotation force of the motor through a predetermined gear (not illustrated). Accordingly, to engage such predetermined gear, gear teeth 431 may be formed on the outer circumference of the driving cam 430 so that the rotation force can be applied and/or transferred from the motor and its predetermined gear. Also, inside the driving cam 430 may be provided a cam profile 435 in a predetermined shape. The cam profile 435 may be provided to have a depth and/or width corresponding to an operating lever 445 of the cam lever 440 which will be described later and sufficient to enable the operating lever 445 to move between a waiting position and a printing position when the driving cam 430 rotates. See FIG. 5, for example.

The driving cam 430, according to an embodiment of the present general inventive concept, can be provided on one end part of the TPH 411, but a pair of driving cams 430 may be provided on opposite end parts of the TPH 411 depending on the sizes of the TPH 411 and the printing paper.

As illustrated in FIG. 5 according to an embodiment of the present general inventive concept, a cam profile 435 can be formed to have a different (i.e., varying; for example, it may be that R1>R2>R3 so that the operating lever 445 gets closer to center ‘C’ when traveling towards end point ‘n’ from the direction of starting point ‘m’ along cam profile 435 with rotation of the driving cam 430 as illustrated in FIG. 5) radius from the center C of the driving cam 430 (R1≠R2≠R3). The cam profile 435 can be formed so that a height difference (R1−R3=h) exists between a starting point ‘m’, (displaced a radius R1 from the center C) and an ending point ‘n’ (displaced a radius R3 from the center C) and which height may correspond to the TPH 411 between its waiting position (e.g., when operating lever 445 is at or closer to starting point ‘m’) and the printing position (e.g., when the operating lever 445 is at or closer to ending point ‘n’) depending upon the thickness of the printing paper and/or the amount of heat and/or pressure required to print a desired image of a certain resolution on the printing paper. Also, the shape between the starting point ‘m’ and the ending point ‘n’ is desirably provided so that the radius R (e.g., R1, R2 and R3) from the center C of the driving cam 430 is gradually changed (e.g., gradually or incrementally increased) by a sequential value to transfer the static pressure applied by the cam lever 440 in smaller and smaller impulse increments.

Furthermore, pursuant to an embodiment of the present general inventive concept, as the radius R (e.g., R1, R2 and R3) from the center C of the cam profile 435 may be sequentially decreased from R1 to R3, the amount of a torque transferred to the cam lever 440 may be changed. Accordingly, in the case that the operating lever 445 is positioned on the ending point ‘n’ of the cam profile 435, the amount of the torque transferred to the cam lever 440 may be maximized (or increased as the operating lever moves toward end point ‘n’ from the direction of starting point ‘m’).

Also, pursuant to an embodiment of the present general inventive concept, as the radius of the cam profile 435 decreases from R1 to R3, the rotating speed of the driving cam 430 may proportionately increase. That is, the rotating speed of the driving cam 430 can be easily controlled according to the shape of the cam profile and/or the radius R (e.g., R1, R2 and R3) from center C of the cam profile 435.

Meanwhile, according to an embodiment of the present general inventive concept, in a special area of the cam profile 435 (e.g., in a portion of a circumference of cam profile 435), for example, the radius R1 or R2 etc. may be unchanged. As the radius (e.g., R1 or R2, etc.) from the center C of the driving cam 430 remains unchanged, such configuration can be used to enable the main pressurizing part 447a of the cam lever 440 to stably apply pressure to the TPH 411. Here, the length of the area (e.g., 2πR1, 2πR2, 2πRₒₜₕₑᵣ, etc. of the cam profile 435) having the same (unchanged) radius may be provided to be similar to the radius of the main pressurizing part 447a (for example, measured from its rotational axis at rotating shaft 443 and/or shaft coupling part 441) of the cam lever 440.

According to various embodiments of the present general inventive concept, the shape of the cam profile 435 may be properly provided in consideration of the size of the driving cam 430, the height between the waiting position and the printing position of the TPH 411, and/or the shape of the main pressurizing part 447a and the auxiliary pressurizing part 447b of the cam lever 440.

Also, the cam profile 435, according to an embodiment of the present general inventive concept, may be provided so that the operating lever 445 can move from the waiting position to the printing position when the driving cam 430 rotates once, but may be provided so that the operating lever 445 can move to a proper height when the driving cam 430 rotates (e.g., a half rotation, a double rotation, or some other fractional rotation or multiple rotation) as necessary. This may be determined (adjusted, altered etc.) in consideration of a desired printing speed and/or printing resolution.

As illustrated in the embodiment of FIG. 5 of the present general inventive concept, the cam lever 440 can be used to reciprocate in a predetermined area engaged with the rotation of the driving cam 430 to enable the TPH part 410 and the supporting arm 420 to move between the waiting position and the printing position. The cam lever 440 can include a shaft coupling part 441 to be coupled to a rotating shaft 443, an operating lever 445 which is provided to be separate from the shaft coupling part 441 by a predetermined distance (e.g., L₁) to be coupled to the cam profile 435 of the driving cam 430, a main pressurizing part 447a which may be formed to have a regular radius from the shaft coupling part 441 used to apply pressure to the TPH 411, and an auxiliary pressurizing part 447b which may be formed to be separate from the main pressurizing part 447a used to contactedly apply pressure to the pressurizing projection 427 of the supporting arm 420.

The shaft coupling part 441 may be provided in the shape of D, a non-circular shape to correspond to the shape of the rotating shaft 443 in which a predetermined area (e.g., of a circular arc) may be abstracted from a circular shape. The shaft coupling part 441 may be press-fitted with the rotating shaft 443 so that it can rotate integrally with the rotating shaft 443.

The operating lever 445 (of cam lever 440) can be provided to be separate from the shaft coupling part 441 by a predetermined distance (e.g., L₁), and may be projected to be coupled to the cam profile 435 of the driving cam 430. The operating lever 445 may be movably guided by the cam profile 435 in a coupled state when the driving cam 430 rotates. Accordingly, the rotating shaft 443 moves in rotation with the operating lever 445 (moving relative to cam profile 435 according to rotation of driving cam 430, for example) to enable the cam lever 440 to rotate. The rotating shaft 443 can be coupled to the inside of the casing 110 to facilitate the rotation (or movement) of the cam lever 440.

As illustrated in the embodiment of FIG. 4B of the present general inventive concept, the main pressurizing part 447a rotates when the operating lever 445 moves along the cam profile 435 and directly applies pressure to the TPH 411. The main pressurizing part 447a may be designed to apply pressure to the TPH 411 when the operating lever 445 is positioned in a part where the radius of the cam profile 435 is uniform. Where the radius of the cam profile 435 is uniform and the radius of the main pressurizing part 447a is also uniform, the TPH 411 can maintain the same position (e.g, vertical position), and the supporting arm 420 coupled to the TPH 411 may also be pressurized to maintain a uniform position (e.g., vertical position).

The auxiliary pressurizing part 447b may be connected with the pressurizing projection 427 of the supporting arm 420 in the waiting position, and the auxiliary pressurizing part 447b may be properly curved (or have some other suitable outer profile) so that the pressurizing projection 427 can move along the shape (e.g., outer profile) of the auxiliary pressurizing part 447b and rotate the cam lever 440 when the driving cam 430 rotates. Here, the curved shape (e.g., or other outer profile) of the auxiliary pressurizing part 447b can be provided to correspond to the shape of the cam profile 435 and to a moving trace of the supporting arm 420 so that the pressurizing projection 427 can slidingly move along (e.g., the outer profile or outer curved shape of) the auxiliary pressurizing part 447b together with movement of the main pressurizing part 447a to apply pressure to TPH 411 and to the supporting arm 420 (e.g., to move the TPH 411 between its waiting position and its printing position).

Here, the speed of the driving cam 430 and the shape of the cam profile 435 may be changed by controlling the distance L1 to the operating lever 445 and the distance L2 to the auxiliary pressurizing part 447b from the rotating shaft 443.

Meanwhile, according to an embodiment of the present general inventive concept, as the circumferential length of the main pressurizing part 447a gets longer in the case that the distance L1 is provided to be shorter, it may be necessary to slow down the speed of the driving cam 430.

In other words, according to the circumferential shape (and/or size) of the cam lever 440 (e.g., size of L1 and/or L2, and/or size/shape of parts 447a and/or 447b), the speed of the driving gear 430 may be decreased or increased. This can have an effect to reduce the number of parts (in a printing apparatus) and to slow down rotational speed smoothly in comparison to controlling the operating speed of a cam lever 440 having a plurality of conventional gears. Accordingly, the shape of the cam lever 440 is can be designed in consideration of the circumferential shapes (and/or sizes) of the driving cam 430 (and/or its cam profile 435) and that of the supporting arm 420, as well as in consideration of the desired rotational speed of the driving cam 430.

Meanwhile, because the driving cam 430 may be provided on only one side of the TPH part 410 according to an embodiment of the present general inventive concept, the cam lever 440 provided on the one side corresponding to the side of the driving cam 430 may include all the above-described configurations. As illustrated in the embodiment of FIG. 3B of the present general inventive concept, the cam lever 440 on the side where the driving cam 430 is not provided does not include the operating lever 445 coupled to the cam profile 435 of the driving cam 430. Also, as illustrated in FIG. 3B, on the same side where the driving cam 430 is not provided, the cam lever 440 may be provided with an auxiliary pressurizing projection 427a designed to engage with the main pressurizing part 447a.

The operating process of the image forming apparatus 11 with this configuration, according to one or more embodiments of the present general inventive concept, will be further described with reference to FIGS. 3, 3A, 3B, 4A, 4B, 5, 6 and 7.

First, for example, when an output signal is applied, a printing paper is fed from the paper feeding part 120. The fed paper is transferred to the inside of the casing 110. At this time, the ink ribbon supplying roller 131 supplies a yellow ink ribbon 1R and rightly arranges the yellow ink ribbon 1R on an image printing side of the printing paper.

Here, as illustrated in FIGS. 4A to 4B, the TPH part 410 is positioned in the waiting position separated from a platen roller 45 on which the printing paper and the ink ribbon are to be disposed. When the printing paper and the ink ribbon are arranged to correspond to each other, a motor (not illustrated) rotates and a gear (not illustrated), in direct or indirect connection with the driving cam 430, are used to rotate the driving cam 430.

When the driving cam 430 rotates clockwise as illustrated in FIG. 5, the operating lever 445 of the cam lever 440 moves along the cam profile 435 of the driving cam 430. At this time, as illustrated in FIG. 5, for example, when the driving cam 430 rotates in the clockwise direction (see dashed arrow), the operating lever 445 moves from the starting point ‘m’ of the cam profile 435 towards the ending point ‘n’ and can descend as much as a displacement ‘h’ corresponding to the radius difference between the starting point ‘m’ radius and the ending point ‘n’ radius (e.g., R1−R3=h). Accordingly, the cam lever 440 rotates counterclockwise (in response to the clockwise rotation of the driving cam 430, for example), and the main pressurizing part 447a of the cam lever 440 can directly apply pressure (e.g., downward in the orientation illustrated in FIG. 5) to the TPH 411.

When the driving cam 430 continues to rotate in the clockwise direction, the pressurizing projection 427 (connected with the auxiliary pressurizing part 447b of the cam lever 440) slidingly moves along (e.g., the outer profile of) the auxiliary pressurizing part 447b. Continued rotation of driving cam 430 also causes the arm main body 421 to be pressurized by the main pressurizing part 447a via auxiliary pressurizing projection 427a as illustrated in FIG. 3B.

As the pressurizing projection 427 is pressurized by the auxiliary pressurizing part 447b, the elastic part coupling part 425 is pressurized downward to apply pressure to the elastic member 415. Accordingly, the elastic member 415 is used elastically to apply pressure to the TPH 411. The TPH 411, in turn, when in the printing position is able to apply (and/or transfer) heat and/or pressure to the ink ribbon 1R held against the printing paper. In the printing position, the platen roller 145 (provided to face the TPH 411) holds the paper and the ink ribbon 1R against the TPH 411 to permit transfer of the ink with adequate printing pressure needed to print the image on the paper.

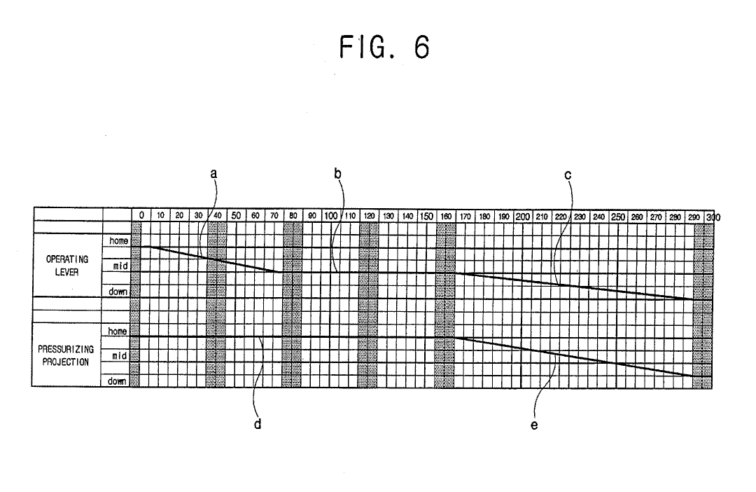

According to one or more embodiments of the present general inventive concept, FIG. 6 is a graph that plots vertical position changes of the operating lever 445 and that of the pressurizing projection 427 versus the degrees of rotation of the driving cam 430.

As illustrated in the graph of FIG. 6, when the driving cam 430 starts rotating, the position of the operating lever 445 gradually descends to correspond to 80° rotation (area a). Also, the corresponding position from the 80° to 160° rotation (area b) is uniformly maintained and the corresponding position from 160° to 300° (area c) further descends as indicated. This result is observed in this embodiment of the present general inventive concept because the radius of the cam profile 435 coupled to the operating lever 445 is gradually reduced from 0° (a starting point, m) to 80° (e.g., R1 gradually reduced to R2), and the radius from 80° to 160° is not changed (e.g., R2 is maintained constant), and the radius from 160° to 300° (e.g., R2 gradually reduced to R3) is further incrementally reduced in a gradual fashion (e.g., incremental reductions of 0.1, 0.2, 0.3, . . . , 0.6, . . . . etc. inches—or millimeters—, as desired) to go from R2 to R3.

Meanwhile, the pressurizing projection 427 does not change (area d) in a position until the driving cam 430 reaches 160° of rotation, and then its position gradually descends from 160° to 290° or 300° (area e). Thus, the height of the arm main body 421 does not begin to change until 160° of rotation is reached because the position of the pressurizing projection 427 does not sufficiently engage to move along the auxiliary pressurizing part 447b until the rotation is at and beyond 160°, according to an embodiment of the present general inventive concept.

Meanwhile, as illustrated in FIG. 6, the TPH 411 is not pressurized by the main pressurizing part 447a until the TPH 411 moves from the waiting position (areas a and/or b) to the start of the printing position (beginning of area c at 160° of rotation and beyond). In the printing position, the TPH 411 is able to apply the requisite heat and/or pressure to the ink ribbon R to form an image on the printing paper. Also, after the driving cam 430 rotates as much as 300°, as illustrated in FIG. 3B, the pressurizing projection 427a is pressurized by the main pressurizing part 447a and the elastic part 415 is able to elastically apply pressure to the TPH 411 to maintain the printing position.

Meanwhile, after the TPH 411 has applied pressure to, for example, the yellow ink ribbon 1R and forms an image on the printing paper, the driving cam 430 is rotated counterclockwise. Accordingly, the cam lever 440 is once again ready to be rotated in the clockwise direction. In other words, the driving cam 430 may be rotated in a reciprocating fashion according to an embodiment of the present general inventive concept.

During clockwise rotation, the operating lever 445 and the pressurizing projection 427 trace their position backwards along the plot illustrated in FIG. 6 (i.e., from the right to the left—or—back from 300° rotation back towards 0° rotation). As the pressurizing projection 427 ascends, the elastic force/pressure previously applied to the TPH 411 is reduced and the TPH 411 gradually ascends. When the driving cam 430 rotates back to as much as 160° (area b), the supporting arm 420 may be quickly returned to the waiting position by the elastic force of the torsion spring 424 provided on the rotating shaft 423 of the supporting arm 420, according to an embodiment of the present general inventive concept.

At this time, the ink ribbon return roller 133 is used to accept the used yellow ink ribbon 1R and the ink supplying roller 131 is used to supply a magenta ink ribbon 1R. The printing paper on which a yellow image is formed is ultimately moved toward the point 1B in FIG. 3 and then returned to the TPH 411 for further printing with a different color, for example, as needed.

Accordingly, the TPH assembly 400 moves the TPH 411 from the waiting position to the printing position through the above described process to form a magenta image on the printing paper. This process is repeated for a cyanic color, and an overcoating color, and when the image forming process is completed, the printing paper is discharged through the paper discharging part 170 to point 1A, according to one or more embodiments of the present general inventive concept.

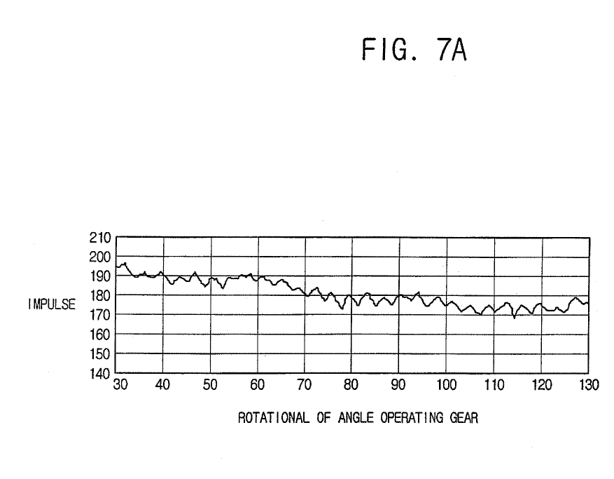

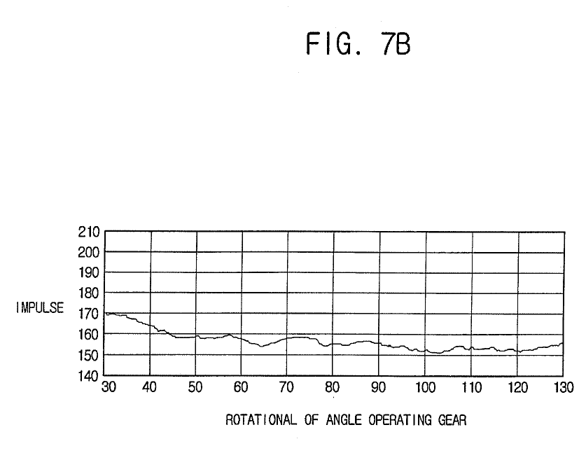

FIG. 7A is a graph plotting the number of impulses (together with the peaks and troughs illustrated) transferred to the up-down gear 46 when the conventional TPH assembly 40A is shuttled between the waiting position and the printing position by an engagement of conventional gears. For comparison, FIG. 7B is a graph plotting the impulses transferred to the rotating shaft 443 of the cam lever 440 when the TPH assembly 400 according to an embodiment of the present general inventive concept is reciprocated between the waiting position and the printing position.

As illustrated in FIG. 7A, the number of impulses that are sequentially transferred to the conventional TPH assembly 40A whenever teeth of the up-down gear 46 are engaged according to the rotation of the driving gear 47a. On the other hand, the number of the impulses delivered is reduced and their abrupt change of direction is also reduced when using the TPH assembly 400 according to an embodiment of the present general inventive concept. This can be discerned by the less sharp shape (e.g., peaks and/or troughs) of the curve of FIG. 7B as well as the reduced number of impulses plotted therein against the degrees of rotation of the driving cam 430. In FIG. 7A, the number of impulses transferred are within a range of 200˜170 when using the conventional assembly 40A; whereas, as indicated in FIG. 7B, the number of impulses transferred are within a range of 170˜150 when using an embodiment of the present general inventive concept. Such changes are a marked improvement over the performance of a conventional TPH assembly as noted herein.

Accordingly, because the number of impulses transferred to the rotating shaft 443 of the cam lever 440 in an embodiment of the present general inventive concept is smaller than that of the conventional TPH assembly 40A, the shaft coupling part 441 is subject to less wear and tear. Therefore, a TPH assembly according to an embodiment of the present general inventive concept may be used stably for a longer time and does not require the extra expense of incorporating unnecessarily hardened components to withstand the more pronounced and increased number of transferred impulses of a conventional TPH assembly.

While the above described embodiments of the present general inventive concept have been described in the context of a dye sublimation type image forming apparatus used to transfer ink on the ink ribbon onto a printing paper, the TPH assembly according to one or more embodiments of the present general inventive concept may be used with a direct thermal type image forming apparatus such as may be used to form an image on a printing paper having a thermal chromogenic layer to form images of varying colors depending upon the amount and/or duration of heat applied without the use of extra ink ribbons.

As described above, the image forming apparatus according to one or more embodiments of the present general inventive concept can be used stably for a longer time (than a conventional image forming apparatus) because a smaller number of impulses are transferred to the rotating shaft when the TPH part is reciprocated between the waiting position and the printing position.

Also, according to one or more embodiments of the present general inventive concept, as pressure is transferred by the shape of the cam profile, transferred by the main and auxiliary pressurizing parts 447a and 447b of the cam lever 440, and transferred by the elastic member 415, the overall pressure applied to the ink ribbon 1R, and the printing paper is sufficient to enhance the image quality of the image formed on the printing paper.

Furthermore, according to other embodiments of the present general inventive concept, because the cam levers 440 are provided on opposite end sides of the TPH 411 to transfer the requisite pressure, a more uniform pressure can be applied to the ink ribbon and ultimately to the printing paper in contact with the ink ribbon.

Also, according to other embodiments of the present general inventive concept, the speed (e.g., reciprocating speed between the waiting position and the printing position) of the cam lever 440 can be adjusted more smoothly according to the shape and/or size of the cam profile used.

Also, without adding extra additional parts, the moving distance (e.g., h) of the TPH 411 reciprocating between the waiting and the printing positions can be readily adjusted by a corresponding design change of the shape of the cam profile.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming apparatus comprising:
a thermal print head part;
a supporting arm coupled to the thermal print head part to support the thermal print head part to move between a printing position and a waiting position;
a driving cam having a cam profile; and
a cam lever having an operating lever to move along the cam profile, and an auxiliary pressurizing part to move the thermal print head part between the waiting position and the printing position according to a movement of the operating lever.

2. The image forming apparatus of claim 1, wherein a rotation of the driving cam rotates the cam profile, and
wherein the cam profile is provided so that its radius is gradually reduced.

3. The image forming apparatus of claim 2, wherein the cam profile has a spiral shape with a starting radius and an ending radius, and wherein a difference between the starting radius and the ending radius of the cam profile corresponds to a displacement difference between the waiting position and the ending printing position.

4. The image forming apparatus of claim 3, wherein the starting radius is larger than the ending radius.

5. The image forming apparatus of claim 4, wherein the starting radius is reduced down to the ending radius.

6. The image forming apparatus of claim 5, wherein the starting radius is reduced to an intermediate radius and the intermediate radius is reduced to the ending radius.

7. The image forming apparatus of claim 1, wherein the cam lever further comprises a main pressurizing part having a uniform outer circumference.

8. The image forming apparatus of claim 7, further comprising a second supporting arm having an auxiliary pressurizing projection to contact the main pressurizing part.

9. The image forming apparatus of claim 7, wherein the supporting arm comprises a main pressurizing projection to contact the auxiliary pressurizing part.

10. The image forming apparatus of claim 2, wherein the cam profile accommodates the operating lever to move along the cam profile.

11. The image forming apparatus of claim 1, wherein the thermal print head part comprises a thermal print head and an elastic part to apply an elastic force to the thermal print head.

12. The image forming apparatus of claim 11, wherein the supporting arm comprises an elastic coupling part coupled to the elastic part.

13. The image forming apparatus of claim 12, wherein the supporting arm further comprises:
an elastic part pressurizing projection to be pressurized by the auxiliary pressurizing part when the cam lever is rotated so that the elastic coupling part applies pressure to the elastic part.

14. The image forming apparatus of claim 1, wherein the cam lever further comprises:
a main pressurizing part having an outer circumference defined by a single predetermined radius from a rotating shaft connected to the cam lever.

15. The image forming apparatus of claim 12,
wherein some area on an outer circumference of the cam lever is curved so that the elastic part pressurizing projection can slidingly move along the outer circumference when the cam lever rotates.

16. The image forming apparatus of claim 1, wherein the cam lever comprises a shaft coupling part coupled to a rotating shaft having a non-circular cross-sectional shape.

17. The image forming apparatus according to claim 1, further comprising:
an elastic member to apply an elastic force to the supporting arm to move the thermal print head part form the printing position to the waiting position.

18. The image forming apparatus of claim 1, further comprising:
a second supporting arm, wherein the supporting arm and the second supporting arm are disposed on opposite ends of the thermal print head part.

19. The image forming apparatus of claim 1, wherein the driving cam comprises gear teeth on its outer circumference.

20. The image forming apparatus of claim 1, wherein the supporting arm has a free end part separated from a predetermined rotating center point, and wherein the free end part is coupled to the thermal print head part.

21. An image forming apparatus comprising:
a thermal print head part to pressurize and to heat a printing paper;
a supporting arm in which a free end part separated from a predetermined rotating center point is coupled to the thermal print head part to support the thermal print head part to move between a printing position and a waiting position;
a driving cam having a cam profile; and
a cam lever having an operating lever to move along the cam profile, and having a main pressurizing part rotating about a rotating shaft to apply pressure to the thermal print head part to move the thermal print head part to the printing position according to a movement of the operating lever.

22. The image forming apparatus of claim 21, wherein the thermal print head part includes a print head to print an image on the printing paper, and
wherein the printing paper includes a thermal chromogenic layer to form the image thereon.

23. A thermal print head assembly comprising:
a thermal print head part to apply heat and pressure to an ink ribbon and a printing paper to form an image on the printing paper;
a supporting arm in which a free end part separated from a predetermined rotating center point is coupled to the thermal print head part to support the thermal print head part to move between a printing position and a waiting position;
a driving cam having a cam profile; and
a cam lever having an operating lever to move along the cam profile, and to move the thermal print head part to the printing position according to a movement of the operating lever.

24. A print head assembly comprising:
a print head part to apply heat or pressure to a printing paper to form an image on the printing paper with an ink supply; and
a driving cam coupled to the print head part, the driving cam having a cam profile to move the print head part between a waiting position and a printing position upon rotation of the driving cam.

25. The print head assembly of claim 24, wherein the driving cam is associated with an operating lever to move along the cam profile upon rotation of the driving cam to facilitate movement of the print head part between the waiting position and the printing position, and
wherein the cam profile is shaped to move the operating lever along or within the cam profile.

26. The print head assembly of claim 25, wherein the cam profile has a spiral shape with a starting radius and an ending radius, and
wherein the cam profile has a starting point and an ending point.

27. The print head assembly of claim 26, wherein the starting point corresponds to the waiting position and the ending point corresponds to the printing position.

28. The print head assembly of claim 27, wherein the driving cam is coupled to the print head part via a cam lever, and
wherein the cam lever comprises the operating lever.

29. The print head assembly of claim 28, wherein the cam lever comprises the operating lever to slidably move or to rotatably move within the cam profile upon rotation of the driving cam.

30. The print head assembly of claim 29, wherein the cam profile is formed in the driving cam.

31. A method of reducing the number of impulses transferred by a print head assembly having a driving cam with a cam profile, an operating lever and a print head part, the method comprising:
coupling the operating lever to move the print head part between a waiting position and a printing position upon rotation of the driving cam and the cam profile;
coupling the operating lever to move along the cam profile upon rotation of the driving cam;
rotating the driving cam;
moving the operating lever along the cam profile by rotating the driving cam; and
moving the print head part between the waiting position and the printing position in correspondence with rotating the driving cam and moving the operating lever along the cam profile.

32. The method of claim 31, wherein the cam profile has a spiral shape with a starting radius that gradually decreases to an ending radius.
